(19) United States
(12) Patent Application Publication
(10) Pub. No.: US 2016/0217156 A1
(43) Pub. Date: Jul. 28, 2016

(54) Relationship Status Website

(71) Applicant: Blanca AIicia Arriola Nunez, Siler City, NC (US)

(72) Inventor: Blanca AIicia Arriola Nunez, Siler City, NC (US)

(21) Appl. No.: 15/004,746

(22) Filed: Jan. 22, 2016

Related U.S. Application Data
(60) Provisional application No. 62/106,702, filed on Jan. 22, 2015.

(51) Int. Cl. G06F 17/30; H04L 29/08

(52) U.S. Cl. CPC G06F 17/30247; G06F 17/30864; H04L 67/306; G06F 17/30554

(57) ABSTRACT

A relationship status website identifies a significant other with whom the user is involved in a romantic relationship. The user may upload one or more photos of the significant other. Other members may access the website to learn whether a potential romantic partner is already involved in a relationship and is attempting to cheat. The website relies on image recognition software features to compare the uploaded photo of a potential partner with the photos of other members' established significant others. Images used for comparison are limited to those uploaded by users within a predetermined radius. Other identifying features may also be uploaded by each user and compared to the features of potential romantic partners by other members. The user may also file a complaint regarding the cheating behavior of a current or former significant other.

### CROSS-REFERENCE TO RELATED APPLICATIONS

This Application claims the benefit of U.S. Provisional Application No. 62/106,702, filed Jan. 22, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to Internet services and in particular to a relationship status website. In today's world, romantic relationships have become more and more vulnerable. Cheating has become an epidemic. The cheaters often conceal the existence of a marriage or romantic relationship in order to obtain new partners, since the number of potential romantic partners who would date a cheater is limited. This behavior opens the possibility of innovative preventive measures. A relationship status website, which enables a user to check the relationship status of a potential romantic partner, would resolve this problem.

### SUMMARY OF THE INVENTION

Accordingly, the invention is directed to a relationship status website. The user may securely establish membership on the website and identify a significant other with whom the user is involved in a romantic relationship, uploading one or more images of the significant other. Other members may access the website to learn whether a potential romantic partner is already involved in a relationship and is attempting to cheat. Due to the frequent use of aliases, the website relies on image recognition software features to compare the uploaded image of a potential partner with the images of other members' established significant others. Images used for comparison are limited to those uploaded by users within a predetermined radius, such as 50 miles. Other identifying features such as name, height, weight, tattoos, and the make, model, year, and color of the vehicle driven by a significant other may also be uploaded by each user, and compared to the features of potential romantic partners by other members. The user may also file a complaint regarding the cheating behavior of a current or former significant other.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front perspective view of a laptop which is accessing the first exemplary embodiment, displaying the homepage 10, the search button 11, the register button 12, the log-in button 13, the laptop 14A, and the visual display 15.

FIG. 2 is a front view of a smartphone which is accessing the first exemplary embodiment, displaying the homepage 10, the search button 11, the register button 12, the smartphone 14B, and the visual display 15.

FIG. 3 is a flow chart of the website structure and process.

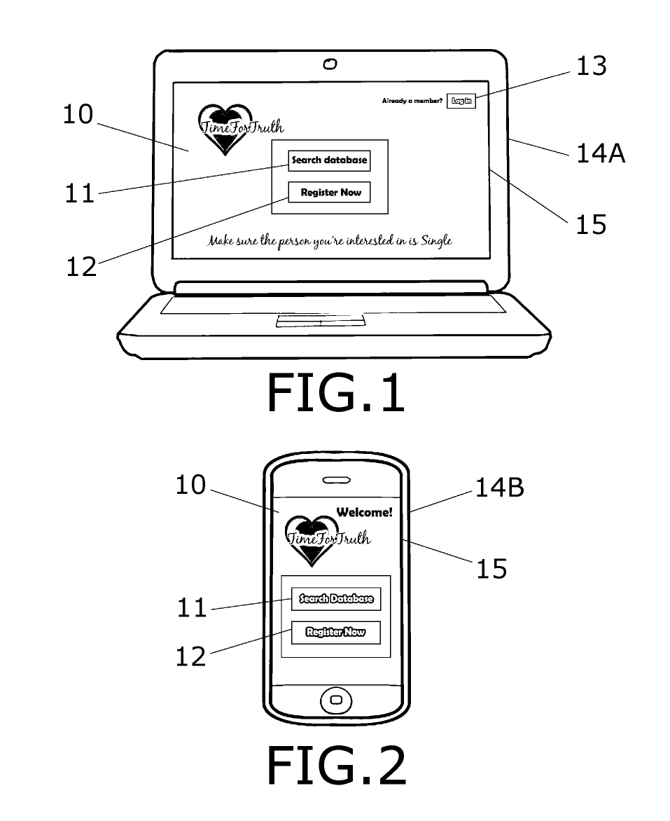

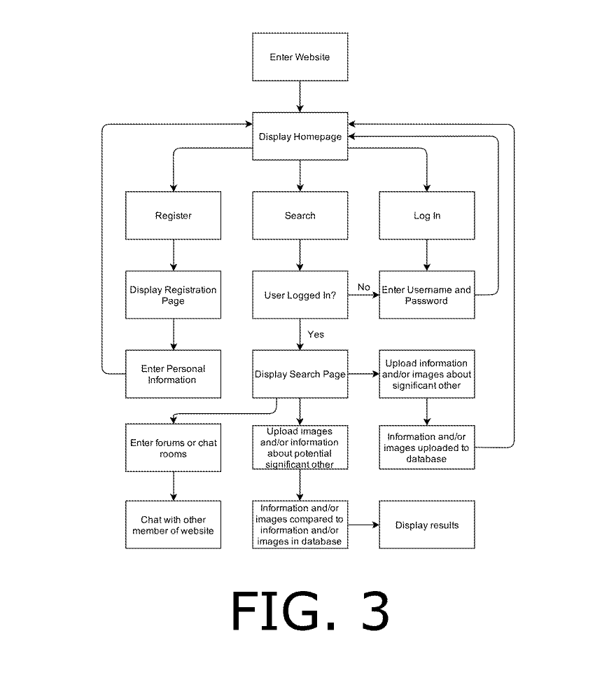

### DETAILED DESCRIPTION OF THE INVENTION

Referring now to the invention in more detail, the invention is directed to a relationship status website.

The first exemplary embodiment is comprised of a website where the user may securely establish membership. The user may use the website and identify a significant other with whom the user is involved in a romantic relationship or marriage, uploading one or more images of the significant other. Other members may access the website to learn whether a potential romantic partner is already involved in a relationship and is attempting to cheat.

The website is comprised of a homepage 10 and a plurality of additional pages. The homepage 10 provides a search button 11 and a register button 12, and may also provide a log-in button 13, which causes a pop-up window to appear requesting the user's username and password. If a log-in button 13 is not provided, clicking on the search button 11 without logging in will cause the pop-up window to appear. If the user has logged in, clicking on the search button causes a search page to be displayed with additional buttons, which may be used to upload one or more images of a potential romantic partner or significant other, enter other identifying information about a significant other, and perform other related functions.

Clicking on the register button 12 causes a registration page to be displayed with additional buttons, which may be used to create a membership account. The user is asked to select a username and secure password, and enter the user's zip code to establish a starting point for searches. The user may also be asked to pay a membership fee to the managing entity of the website with a credit or debit card, which may be a one-time charge or a periodic fee, such as a monthly fee.

Registration information is used to partially populate the cells of a personal page or profile for the user. The user may elect to populate any or all of the remaining cells. Cells are provided for the length of the relationship, names and ages of any children produced by the relationship and any children from previous relationships, the type of relationship such as a marriage or engagement, and the location where the user and the significant other first met. Additional cells may also be provided for other information, as well as a brief statement by the user.

If the user reports that the type of relationship is a marriage, the user is required to provide a copy of the marriage license and/or marriage certificate before proceeding to use other features of the website. The marriage license and/or certificate may be scanned and uploaded, or delivered by mail or facsimile transmission to the managing entity of the website, which will review the marriage license and/or certificate and verify that it is genuine.

The website provides a members-only discussion forum, accessible from the search page, enabling the user to exchange messages and chat with other members. Discussion threads on the forum may be used to ask for advice from other members, or seek out another member who may be tired of being cheated on and is looking for a new relationship based on trust and full, truthful disclosure. If the user does not provide any information about a significant other, the user may still obtain a membership and access the discussion forum to find a partner, or check on the relationship status of a potential romantic partner. Discussion threads, as well as display advertising with fees paid to the managing entity of the website, may also provide the user information regarding related professional services in the user's area, such as couples counselors and polygraph services.

Due to the frequent use of aliases, the website relies on image recognition software features to compare the uploaded image of a potential partner with the images of other members' established significant others. Images which are used for comparison are limited to those uploaded by users within a predetermined radius of the user's zip code, such as 50 miles. Other identifying features such as name, height, weight, tattoos, e-mail address, Facebook address, Instagram address, home address, cellular telephone number, birthdate, and the make, model, year, and color of the vehicle driven by a significant other may also be uploaded by each user and compared to the features of potential romantic partners by other members. All of the information and images provided by the members of the website are stored in a searchable database.

The user may file a complaint regarding the cheating behavior of a current or former significant other. All of this information may be easily accessed and used by any member of the website to determine whether to pursue a relationship with a potential romantic partner.

The website also provides other information which is available for the user to review. Since the information provided by the user about a significant other is available for viewing by other members, the number of times other members have viewed the information and the user's personal page is tallied, and the tally is available for review by the user.

The user may elect to provide an e-mail address or other personal message box to receive e-mail notifications, if a match was confirmed or a complaint was made against the user or the user's significant other. A notification will be sent to the user's e-mail or personal message box. Alternately, the user may elect not to be notified about others inquiring of the user or significant other, but still allow other members to view the user's personal page. If a match is confirmed the user could choose to exchange information with the member who made the match, in order to resolve the issue and confront the significant other.

The primary purpose of the website is to inform other members that the user is involved in a relationship with the significant other, such that the significant other is not available, and if another member is romantically interested in the significant other, to advise the other member to look elsewhere. A secondary purpose of the website is to either confirm that the user's significant other is faithful, providing the user peace of mind, or notify the user that the significant other is cheating, thus providing the user the option of moving on.

To use the first exemplary embodiment, the user opens the homepage 10 and clicks on the register button 12 to establish a membership account. The user may then log in by clicking on the log-in button 13, and access and operate the main features of the website, including the search function, the discussion forum, and uploading images and other information regarding the user's significant other, by clicking on the search button 11.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A relationship status website comprising, a website wherein a user securely establishes a membership and said user may use said website to compare a potential romantic partner with a database of persons registered as already being in a relationship.

2. The relationship status website of claim 1, wherein a user accesses the website and uploads images and/or information regarding the user's significant other; said images and/or information being uploaded and stored to a database.

3. The relationship status website of claim 2, wherein the website is comprised of a homepage and a plurality of additional pages.

4. The relationship status website of claim 3, wherein said homepage provides a search button, a register button, and a log-in button; said log-in button, when clicked, causes a pop-up window to appear requesting a username and password unique to said user.

5. The relationship status website of claim 3, wherein said homepage provides a search button and a register button; said search button, when clicked, causes a pop-up window to appear requesting a username and password unique to said user followed by a search page; the search page provides additional buttons, which may be used to upload one or more images of a potential romantic partner or significant other, enter other identifying information about a significant other, and perform a search wherein the images of a potential romantic partner and identifying information about the potential romantic partner are compared to images and information stored within said database and image recognition software is used to compare uploaded images to database images.

6. The relationship status website of claim 4, wherein if the user is logged in, clicking on the search button causes a search page to be displayed; the search page provides additional buttons, which may be used to upload one or more images of a potential romantic partner, enter other identifying information about the potential romantic partner, and perform a search wherein the images of a potential romantic partner and identifying information about the potential romantic partner are compared to images and information stored within said database and image recognition software is used to compare uploaded images to database images.

7. The relationship status website of claim 4, wherein clicking on the register button causes a registration page to be displayed; the registration page including additional buttons, which may be used to create a membership account requiring registration information.

8. The relationship status website of claim 7, wherein the user is asked to select a username and secure password, and enter the user's zip code.

9. The relationship status website of claim 7, wherein the user is asked to pay a membership fee to the managing entity of the website with a credit or debit card; said membership fee being either a one-time charge or a periodic fee.

10. The relationship status website of claim 7, wherein the registration information is used to partially populate the cells of a personal page or profile for the user and the user enters additional personal information into the personal page or profile.

11. The relationship status website of claim 10, wherein additional personal information includes the length of a relationship with a significant other, names and ages of any children produced with significant other, any children from previous relationships, the type of relationship (such as a marriage, engagement, or dating), and the location where the user and the significant other first met.

12. The relationship status website of claim 11, wherein if the user provides the type of relationship is a marriage, the user must provide a copy of the marriage license and/or marriage certificate before proceeding to use other features of the website.

13. The relationship status website of claim 6, wherein the website further provides a members-only discussion forum, accessible from the search page, enabling the user to exchange messages and chat with other members within discussion threads.

14. The relationship status website of claim 13, wherein the discussion threads provide advertising which includes information regarding related professional services in the user's area, such as couples counselors and polygraph services.

15. The relationship status website of claim 5, wherein clicking on the register button causes a registration page to be displayed; the registration page including additional buttons, which may be used to create a membership account requiring registration information; the user is asked to select a username and secure password, and enter the user's zip code.

16. The relationship status website of claim 15, wherein the user is asked to pay a membership fee to the managing entity of the website with a credit or debit card; said membership fee being either a one-time charge or a periodic fee.

17. The relationship status website of claim 15, wherein the registration information is used to partially populate the cells of a personal page or profile for the user and the user enters additional personal information into the personal page or profile.

18. The relationship status website of claim 17, wherein additional personal information includes the length of a relationship with a significant other, names and ages of any children produced with significant other, any children from previous relationships, the type of relationship (such as a marriage, engagement, or dating), and the location where the user and the significant other first met.

19. The relationship status website of claim 18, wherein if the user provides the type of relationship is a marriage, the user must provide a copy of the marriage license and/or marriage certificate before proceeding to use other features of the website.
